(19) United States
(12) Patent Application Publication
(10) Pub. No.: US 2023/0401588 A1
(43) Pub. Date: Dec. 14, 2023

(54) AUTOMOTIVE MARKET INTELLIGENCE ENGINE IN AN AUTOMOTIVE DATA ANALYTICS SYSTEM

(71) Applicant: The Boston Consulting Group, LLC, Boston, MA (US)

(72) Inventors: Andrej LEVIN, Schleswig-Holstein (DE); Jens Friedrich Ortmann, Bayern (LU); Yuhang Lu, Munich (DE)

(21) Appl. No.: 17/749,682

(22) Filed: May 20, 2022

(51) Int. Cl. G06Q 30/02; G06N 5/04; G06F 16/2458

(52) U.S. Cl. CPC G06Q 30/0201; G06F 2216/03; G06F 16/2465; G06N 5/04

(57) ABSTRACT

Methods, systems, and computer storage media for providing an automotive data analytics service associated with an automotive data analytics engine in an automotive data analytics system. The automotive data analytics service is provided via an automotive data analytics engine (i.e., an automotive market intelligence engine) that includes a conversion rate engine to generate conversion rates for different car dealerships. A conversion rate is based on a number of visitors to a car dealership location who are inferred to have bought cars from the car dealership location. The automotive data analytics engine supports: aggregating different types of automotive data analytics data; using an automotive data computation engine—having an automotive data analytics model—to process the data; calculating a conversion rate for different types of car dealerships; and generating automotive data analytics results data—including the conversion rate—that is provided for display on a graphical user interface.

### BACKGROUND

Many companies rely on data analytics systems to support discovering useful information, informing conclusions, and decision-making based on data. Data analytics systems can support descriptive analytics and predictive analytics that use historical data as inputs to identify trends and relationships and predict future trends. Data analytics systems can also be used to describe what has happened, what is happening, and what will happen based on different types of models. In particular, analytics techniques implemented in data analytics systems allow for improved data analytics system operations including accelerating data processing speed, analyzing more data, identifying hidden patterns in data, inferring new data, creating a more robust system, and increasing adaptability to changes. In this way, data analytics systems can be used to provide improvements—that are challenging to implement—to address limitations in a variety of industries.

Conventionally, data analytics systems are not equipped with a computing infrastructure and logic to systematically capture automotive distribution data and provide data analytics insights based on the automotive distribution data. In particular, an automotive management system may lack integration with a data analytics system, such that the automotive management system takes advantage of advancements in data analytics techniques. For example, a conventional automotive management system may use unsophisticated data sources, inaccurate tools for collecting customer data, and lack adequate data analytics operations to analyze automotive distribution data and present insights from the analysis. As such, a more comprehensive data analytics system—having an alternative basis for providing data analytics system operations—can improve computing operations and interfaces in data analytics systems.

### SUMMARY

Various aspects of the technology described herein are generally directed to systems, methods, and computer storage media, for among other things, providing an automotive data analytics service associated with an automotive data analytics engine in a data analytics system. The automotive data analytics service is provided via an automotive data analytics engine (i.e., an automotive market intelligence engine) that includes a conversion rate engine to generate conversion rates for different types of car dealerships. A conversion rate refers to a number of visitors to a car dealership—who are inferred to have bought cars from the car dealership—out of a total number of visitors. The automotive data analytics engine supports: (1) aggregating different types of data (e.g., car dealership information data, building footprint data, location tracking data, and car registration data); (2) using an automotive data computation engine—having an automotive data analytics model—to process the data; (3) calculating a conversion rate for different types of car dealerships; and (4) generating automotive data analytics results data—including the conversion rate—that is provided for display on a graphical user interface.

In operation, a count of a number of visitors associated with a car dealership is accessed. The count of the number of visitors is generated based on car dealership information data, building footprint data, and location tracking data. A count of a number of cars sold associated with the car dealership is accessed. The count of the number of cars sold is generated based on a number of car registrations allocated—using an automotive data analytics model—to the car dealership. A conversion rate for the car dealership is generated based on the count of the number of visitors and the count of the number of cars sold. The conversion rate for the car dealership is communicated and caused to be displayed as automotive data analytics results data using automotive data analytics graphical interface elements (e.g., data visualizations).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary data analytics system with an automotive data analytics engine, in which embodiments described herein may be employed;

FIG. 1C is an exemplary schematic associated with a data analytics system with an automotive data analytics engine, in which embodiments described herein may be employed;

FIGS. 2A and 2B are block diagrams of an exemplary data analytics system with an automotive data analytics engine, in which embodiments described herein may be employed;

FIGS. 2C-2K are exemplary schematics associated with a data analytics system with an automotive data analytics engine, in which embodiments described herein may be employed;

FIG. 3 is a flow diagram showing an exemplary method for implementing a data analytics system with an automotive data analytics engine, in accordance with embodiments described herein;

FIG. 4 is a flow diagram showing an exemplary method for implementing a data analytics system with an automotive data analytics engine, in accordance with embodiments described herein;

FIG. 5 is a flow diagram showing an exemplary method for implementing a data analytics system with an automotive data analytics engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

### Overview

By way of background, data analytics systems support discovering useful information, informing conclusions, and decision-making based on data. Data analytics systems can also be used to describe what has happened, what is happening, and what will happen based on different types of models. In particular, analytics techniques implemented in data analytics systems allow for improved data analytics system operations including accelerating data processing speed, analyzing more data, identifying hidden patterns in data, inferring new data, creating a more robust system, and increasing adaptability to changes. Automotive management systems (e.g., computing-based systems) can support providing a variety of different solutions in automotive distribution services—such as, customer relationship management and marketing management—to help increase sales and profitability.

Automotive management systems can be limited to using basic computing techniques and resources for performing automotive management operations and have not adapted to changing advancements in technological tools. Conventionally, data analytics systems are not equipped with a computing infrastructure and logic to systematically capture automotive distribution data and provide data analytics insights based on the automotive distribution data. For example, a conventional automotive management system may use unsophisticated data sources, inaccurate tools for collecting customer data, and lack any data analytics operations to analyze automotive distribution data and present insights from the analysis. Conversion rate refers to a number of visitors that visited a car dealership and were sold cars out of a total number of visitors (e.g., 3200 visitors and 300 cars sold yields a 9.3% conversion rate). And, automotive companies (i.e., car manufactures or Original Equipment Manufacturers “OEM”) lack visibility and data analytics on conversion rate data—including conversion rates and conversion rate comparisons—for cars that are sold at car dealerships. As such, automotive companies lack visibility and data analytics on conversion rate data for their affiliate car dealerships and competitors' car dealerships and the capacity for competitive benchmarking.

Automotive management systems may approximate conversion rates based on techniques that do not provide car dealership data analytics including accurate approximation of conversion rate data and car dealership competitive analysis functionality. For example, a car dealership can include photoelectric barriers to measure entries and exists or have designated employees as counters; however, the measure of entries and exits can be inaccurate when measuring customer visits, not automated, time-consuming, cumbersome, inefficient, and not readily usable to perform automotive data analytics operations for automotive market intelligence including computing conversion rates and car dealership competitive analysis.

Moreover, the automotive companies and car dealerships do not know how well they convert visits to their car dealerships into actual sales of cars from their inventory. For example, the conversion rate data that automotive companies or car dealerships have on the number of visitors to car dealerships can be inaccurate and sparse and cannot be used to make informed decisions on visitors relative to a number of conversions. The lack of transparency on conversion rates of visitors (i.e., automotive market intelligence data) can lead to uninformed allocation of marketing resources and lost sales for automotive companies and car dealerships. Developing an automotive data analytics system that applies data analytics tools to determining automotive market intelligence can be challenging—at least in part—because of the technical limitations described above. As such, a more comprehensive data analytics systems—having an alternative basis for providing data analytics systems operations—can improve computing operations and interfaces in data analytics systems.

Embodiments of the present disclosure are directed to providing an automotive data analytics service associated with an automotive data analytics engine in a data analytics system. The automotive data analytics service is provided via an automotive data analytics engine (i.e., an automotive market intelligence engine) that includes a conversion rate engine to generate conversion rates for different types of car dealerships. A conversion rate refers to a number of visitors to a car dealership—who are inferred to have bought cars from the car dealership—out of a total number of visitors. The automotive data analytics engine supports: (1) aggregating different types of data (e.g., car dealership information data, building footprint data, location tracking data, and car registration data); (2) using an automotive data computation engine—having an automotive data analytics model—to process the data; (3) calculating a conversion rate for different types of car dealerships; and (4) generating automotive data analytics results data—including the conversion rate—that is provided for display on a graphical user interface.

The automotive data analytics engine also supports automotive data benchmarking operations associated with comparing conversion rate data of car dealerships to assess relative performance of car dealerships and market performance of car brands (“brand”). Automotive data benchmarking operations support: (1) generating conversion rates for multiple car dealerships (e.g., a first car dealership having a first conversion rate and a second car dealership having a second conversion rate); (2) generating brand-specific conversion rates where a car dealership is a single-brand car dealership or a multiple-brand car dealership (e.g., a first car dealership is associated only with a conversion rate for a first brand, and a second car dealership is associated with both a conversion rate for a first brand and a conversion rate for a second brand); and (3) generating automotive data analytics results data—including conversion rates and conversion rate comparison data—that is provided for display on a graphical user interface

In operation, a count of a number of visitors associated with a car dealership is accessed. The count of the number of visitors is generated based on car dealership information data, building footprint data, and location tracking data. A count of a number of cars sold associated with the car dealership is accessed. The count of the number of cars sold is generated based on a number of car registrations allocated—using an automotive data analytics model—to the car dealership. A conversion rate for the car dealership is generated based on the count of the number of visitors and the count of the number of cars sold. The conversion rate for the car dealership is communicated and caused to be displayed as automotive data analytics results data using automotive data analytics graphical interface elements (e.g., data visualizations).

In addition, a client device can be configured to communicate a request for automotive data analytics results data and based on the request, receive automotive data analytics results data associated with a single-brand dealership or a multi-brand car dealership. The automotive data analytics result data comprises conversion rates that are generated based on an automotive data analytics model that is calibrated based on historical data comprising car registration data, car registration geographic region data, and car dealership location data. The client device can cause presentation of the automotive data analytics results data associated with the single-brand car dealership, the automotive data analytics results data of the single-brand car dealership comprising a conversion rate of the single-brand car dealership; or cause presentation of automotive data analytics results data associated with the multi-brand car dealership, the automotive data analytics results data of the multi-brand car dealership comprising a plurality of conversion rates of the multi-brand car dealership.

Advantageously, the automotive data analytics system provides highly accurate automotive market intelligence—based on measuring real customer visits—that can provide useful information, inform conclusions, and facilitate decision-making between car dealerships. For example, inferred conversion rates on car sales on a market level can help evaluate performance of car dealerships. Moreover, the automotive data analytics system supports calculating conversion rates for different car dealerships that sell one or more car brands and provides competitive analysis based on benchmarking; in contrast to existing solutions that merely track internal car dealership data only, and have low quality visitor data—resulting in not having conversion rate data.

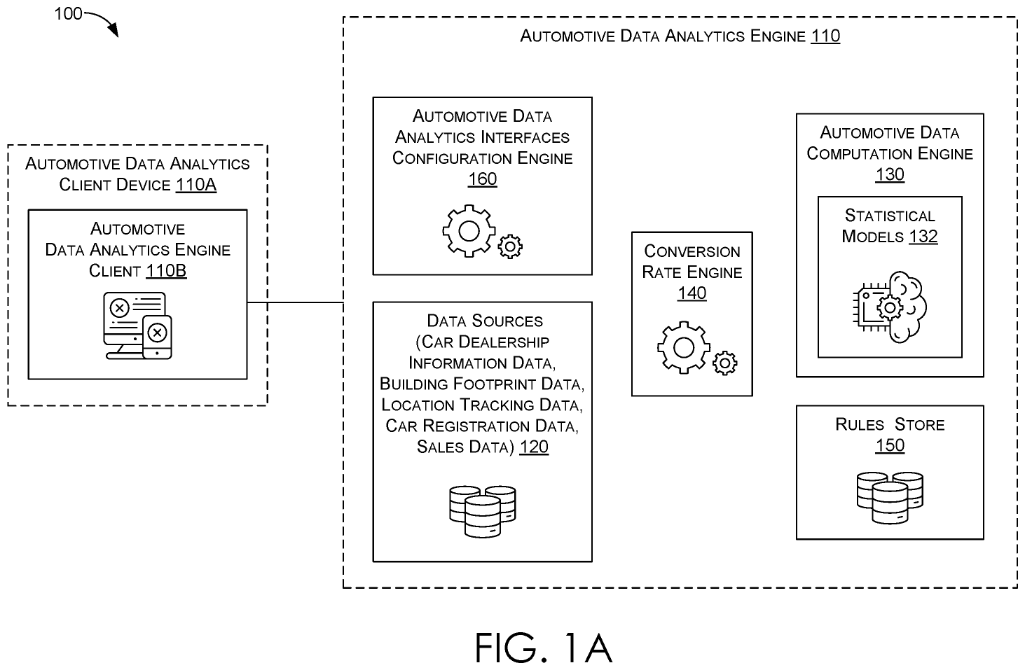

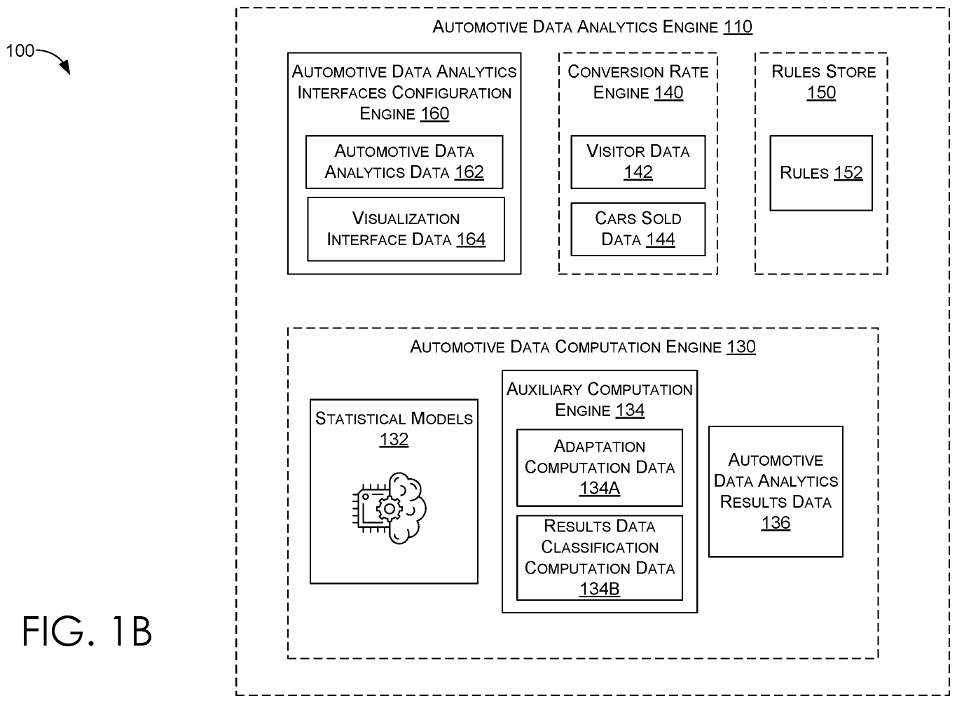

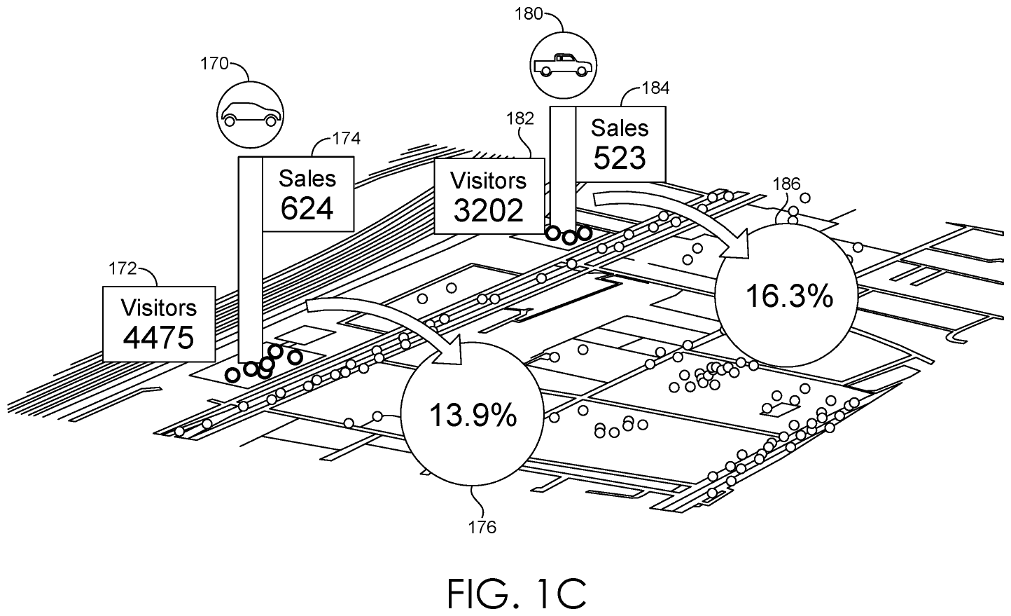

Aspects of the technical solution can be described by way of examples and with reference to FIGS. 1A, 1B, and 1C. FIG. 1A illustrates a data analytics system 100 (“automotive data analytics system”)—including automotive data analytics engine 110 (“automotive market intelligence engine”), automotive data analytics client device 110A, automotive data analytics engine client 110B, data sources 120, automotive data computation engine 130, statistical models 132, conversion rate engine 140, rules store 150, and automotive analytics interfaces configuration engine 160.

With reference to FIG. 1B, FIG. 1B illustrates additional aspects of the automotive data analytics engine 110 in the data analytics system 100. FIG. 1B includes automotive data computation engine 130 having statistical models 132, auxiliary computation engine 134, adaptation computation data 134A, results data classification computation data 134B; conversion rate engine 140 having visitor data 142, cars sold data 144; rules store 150 having rules 152; and automotive analytics interfaces configuration engine 160 having automotive data analytics data 162, and visualization interface data 164.

The data analytics system 100 (i.e., an automotive data analytics system) is responsible for providing an automotive data analytics service associated with the automotive data analytics engine 110 (i.e., an automotive market intelligence engine). The automotive data analytics service (or application) can be a computer program designed to provide the functionality described herein. The automotive data analytics service—via the automotive data analytics engine—is associated with processing automotive data analytics data (e.g., car dealership information data, building footprint data, location tracking data, car registration data, and actual sales data (for testing or calibrating scenarios)). Processing automotive data analytics data supports generating different types of automotive data analytics results data—including conversion rate data and conversion rate comparison data associated with benchmarking.

The automotive data analytics results data can associated with different features (i.e., characteristics and attributes of different types results data) that support presenting the automotive data analytics results data. For example, the automotive data analytics results data include a car dealership information data (e.g., a single-brand car dealership or a multi-brand car dealership), several different brands (i.e., car brands), a geographic region having different hierarchical sub-regions (e.g., city, state, country), a car registration geographic region (e.g., city, state, country), conversion rate data, and conversion rate comparison data. The features of automotive data analytics results data are presented with data visualizations that help understanding how well the different car dealerships and brands are performing in different geographic regions. The automotive data analytics engine 110 can operate with the automotive data analytics client device 110A and the automotive data analytics engine client 110B to provide the automotive data analytics results data with automotive data analytics graphical interface elements (e.g., via the automotive data analytics interface configuration engine 160) for presentation.

Operationally, data sources 120 can be used to store and access different types of data that are used to perform the automotive data analytics operations described herein. Data (e.g., car dealership information data, building footprint data, location tracking data, and car registration data) from the data sources 120 can be processed via the automotive data computation engine 130 using statistical models 132 for generating automotive data analytics results data. Car dealership information data can include name, address, brands, type of car dealership (i.e., new or used), services offered at the dealership (e.g., repair and maintenance) and OEM affiliation. Building footprint data can include an outline of a building with a description of a size, shape, location, etc. Building footprint data can also include pre-processing (e.g., clustering analysis of buildings) results data including identifying entrances, determining exists, and excluding non-car dealership adjacent buildings; and building polygons and corresponding geospatial analysis data (e.g., address, longitude/latitude, purpose, spatial hierarchy). Building footprint data can further refer to a designated spatial region (e.g., a car dealership lot area with buildings and parking spaces) that can be used for location tracking as described herein.

Location tracking data can refer to a location data (e.g., mobile device footfall data). Mobile device location data can be derived from interactions between smart devices or other pieces of technology that transmit, interact, and process location information. The location tracking data can also be geolocation data that is information that can be used identify an electronic device's physical location. The location tracking data can also include auxiliary mobile device data—for example—demographic data associated a user of the mobile device. Mobile device location data and auxiliary mobile device data can be retrieved based on different applications associated with a mobile device. The location tracking data can be processed—using techniques described herein—to help identify visitors to a car dealership and further map corresponding social data and demographic data to the visitors. Other variations and combination of additional data associated with mobile device that can be mapped to the location tracking data are contemplated with embodiments described herein.

Car registration data can include information associated with vehicles that have been registered to uniquely identify the vehicle or vehicle owner within an issuing office region (i.e., car registration geographic region). The car registration data can be stored in a database, with the car registration data having several different features of the car (e.g., new/used, year, make, model, Vehicle Identification Number, etc.). The car registration data can also include an identifier for a car registration geographic region that identifies a geographic region associated with the vehicle. For example, the identifier can be a ZIP code (e.g., ZIP code 12345), a name, or address of an issuing office. The car registration data further identifies the geographic region (i.e., car registration geographic region) assigned to the identifier. As discussed in more detail below, car registrations of a particular car registration geographic region can be allocated to car dealerships that are close to a geographic region of the car registration geographic region. Car dealerships that are close to a particular car registration geographic region are inferred to be the sellers of vehicles that are registered at an issuing office associated with the car registration geographic region.

Data in the data sources 120 can include sales data received from a car dealership or a car manufacturer. The actual sales data can be used in evaluating inferred sales data generated using the automotive data analytical models. The sales data can be used to recalibrate the automotive data analytical models based on comparing the inferred sales data to the actual sales data. For example, comparing the sales data to the inferred sales data can support recalibrating an automotive analytical model associated with allocating car registrations. As such, statistical assumptions of the automotive analytical model can be updated based on observations in actual sales data to help improve how car registrations are allocated to car dealerships.

The automotive data computation engine 130 is responsible for performing computations that support providing the functionality described herein. The automotive data computation engine 130 provides statistical models 132 and auxiliary computation engine 134 for generating different types of automotive data computation results data 136. The automotive data computation engine 130 can specifically support both developing and implementing statistical models and processing the different types of data—from data sources 130 described above. The data from data sources 130 can be processed at the automotive computation engine 130 based on a plurality of rules (i.e., rules 154) in the rules store 150. Rules can generally refer to defined constraints of some aspect of business or data that resolves to either true or false. The rules are intended to assert control on which data are relied upon for performing the automotive data analytics operations.

Rules can be associated with cleansing, transforming, modelling data, presenting data from the data sources 130 or automotive data analytics results data. For example, a first rule can indicate that car registration data associated with a corporation should be filtered out, in particular where the corporation has registered over a threshold number of cars (e.g., 1000 cars) at an issuing office. A second rule can identify filtering features for location tracking data used to estimate a count of number of visitors, where non-car-buying visitors (e.g., employees) can be filtered out based on observing certain patterns (e.g., employee entrance, repeat visits, length of stay) associated with the location tracking data. A third rule can indicate that conversion rates that exceed a threshold confidence score should be presented with a first type of data visualization and conversion rates below a threshold confidence should be presented with a second type of data visualization. Other variations and combination of rules for processing and presenting data and automotive data analytics results data are contemplated with embodiments described herein.

The automotive data computation engine 130 is responsible for implementing an automotive data analytics model that supports allocating car registrations (i.e., car registration data) to car dealerships. The automotive data analytics model is a distribution model that takes car registration data and car dealership information data as inputs and generates an allocated number of car registrations that are assigned to car dealerships. The distribution model is calibrated (e.g., on historical data) such that the automotive data analytics model can be used to compute the allocated number of car registrations to a car dealership. The allocated number of car registrations can correspond to or can be used to approximate or infer a count of a number of cars sold by the car dealership. The automotive data analytical model is generated based at least in part on the features associated with: the car registration data, the car dealership information data, data about the locality of the car dealership, data about the spatial relationship between a spatial car registration geographic region and a spatial car dealership geographic region.

The total number of car registrations can be for specified period time (e.g., one month, three months, six months, one year) and the car dealerships that are allocated car registrations can be car dealerships that are close (e.g., a defined spatial geographic region) to a car registration geographic region. For example, a city may be a defined spatial geographic region, and the city has a issuing office (e.g., issuing office database) with 100 car registrations in a given month. Using the automotive data analytics model, the 100 car registrations can be allocated to a first car dealership (70 car registrations) and a second car dealership (10 car registration) that are within the city—the remaining car registrations (20 car registrations) can allocated to car dealerships outside of the city. In this way, the automotive data analytics model implements a function that determines a likelihood of a car registration to be assigned to a car dealership within or outside of the car registration geographic region. The automotive data analytics model can be adapted to operate in different geographic regions (e.g., city, count, state, country) and corresponding administrative features of their car registration and features of the car registration data, as discussed in more detail below.

The automotive data computation engine 130 can include an auxiliary computation engine 130 having adaptation computation data 134A and results data classification computation data 134B. The adaptation computation data 134A supports adapting (and scaling) the functionality described herein to adaptable features of the data in data sources 130 and geographical regions. For example, the car buying market (e.g., build-to-order market) of a first geographical region (e.g., Germany) may differ from a second car buying market (e.g., build-to-stock market) of a second geographical region (e.g., United States). With a build-to-order market, the period between buying the car and registering the car can be shorter compared to a build-to-stock market (e.g., a few days versus a few months). As such, a period of time between buying the car and registering the car is different for the different car buying markets.

The adaptation computation data 134A can include logic for a configurable lag time for each type of market, such that, allocation of car registration is performed based on the configurable lag time. The adaptation computation data 134A can further include data that supports configuring the relationship between an issuing office for car registrations and a geographic region. For example, an issuing office may be associated with one or more ZIP codes or geographic regions or an issuing office may be associated with a county region. The adaptation data can also include logic to aggregate the data into different administrative or other regions. For example, different political and administrative hierarchies in different markets can be represented. The adaptation data can further support presenting the automotive data analytics results data for different brands in different markets, so that for each market the most relevant brands are available. In this way, the adaptation computation data can include various mechanisms for adapting statistical models to operate and automotive data analytics results to be presented based on features associated with different data types and geographic region.

The automotive data computation 130 can generate automotive data computation results data (“results data) that are scores that indicate a confidence level in the results data. Several different data quality features can be tracked for the different data types for determining the scores. Data quality features can be the presence of extreme values (unlikely high or unlikely low) on any of the input data, or on any of the derived data. For example, an unlikely low number of visitors might be due to a locally low data coverage or mobile device reception which does not reflect true visitors. Other data quality indicators can, for example, include outliers in car registrations per zip code, in conversion rate per dealership or area of the dealership polygon. As such, various limits can be defined in rules (e.g., rules 152) that support scoring results data and automatically classifying the results data for a car dealership into a number of data quality classifications. The results data classification computation data 134B can include results data that are tagged with a specific score or classification associated with a level of confidence in the results data. In this way, based a classification (or score) associated with the results data, the results data can be generated for presentation on the automotive data analytics engine client 110B.

The conversion rate engine 140 is responsible for generating a conversion rate for a car dealership based on visitor data 142 and cars sold data 144. The conversion rate engine 140 can access visitor data 142 and cars sold data 144 for a car dealership and generate a conversion rate based on the visitor data 142 and the car sold data 144. With reference to FIG. 1C, FIG. 1C illustrates aspects of the data analytics system 100 associated with an automotive data analytics service. FIG. 1C includes car dealership 170 and car dealership 180. Car dealership 170 and car dealership 180 are associated with corresponding car dealership information data, building footprint data, location tracking data, and car registration data. Car dealership 170 is associated with visitors 172 (i.e., 4475) and sales 174 (i.e., 624). The visitors 172 can be generated based on the building footprint data and location tracking data associated with the car dealership 170 and the sales 174 can be generated based on car dealership information data and car registration data. A conversion rate 176 (i.e., 624/4475=13.9%) is generated based on sales visitors 172 and sales 174. Car dealership 180 similarly has visitors 182 (i.e., 3202) and sales 184 (i.e., 523) and conversation rate 186 (i.e., 523/3202=16.3%).

The automotive data analytics interfaces configuration engine 160 is responsible for generating different interfaces and data visualizations for the presenting automotive data analytics data 162 (including automotive data analytics results data) and visualization interface data 164. An automotive data analytics interface can be associated with automotive data analytics graphical interface elements that support presenting, summarizing, benchmarking, and filtering automotive data analytics results data. The automotive data analytics data 162 and the visualization interface data 164 can be communicated and caused to be presented via automotive data analytics client device 110A and automotive data analytics engine client 110B. Automotive data analytics interfaces can include support for: (1) selecting a brand to focus on for automotive data analytics data; (2) selecting competitor brands for competitive and benchmarking analysis; (3) displaying market share of conversion across brands and comparison conversion rate data; (4) generating a visualization of a geographical region associated with the automotive data analytics data; and (5) displaying car dealerships, brands, sales, visitors, and corresponding conversion rates.

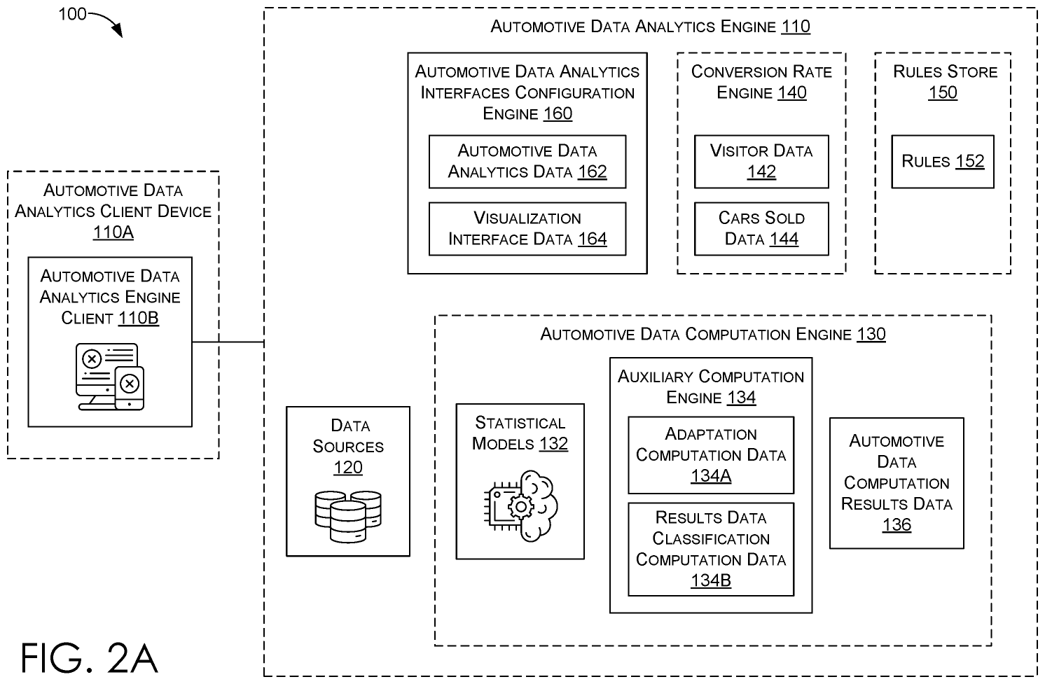

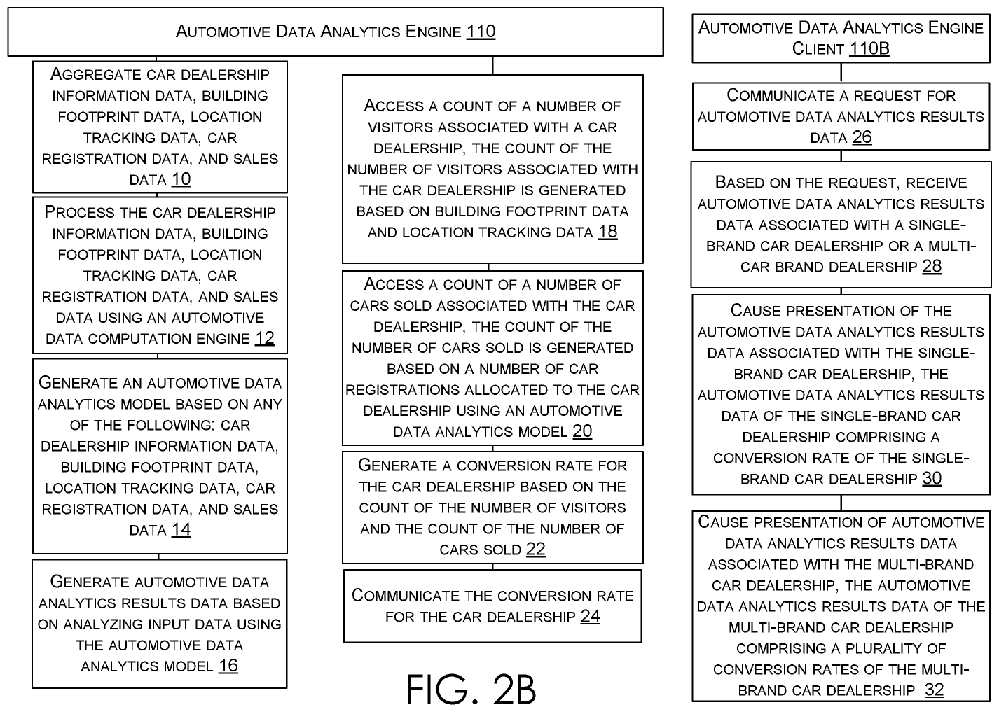

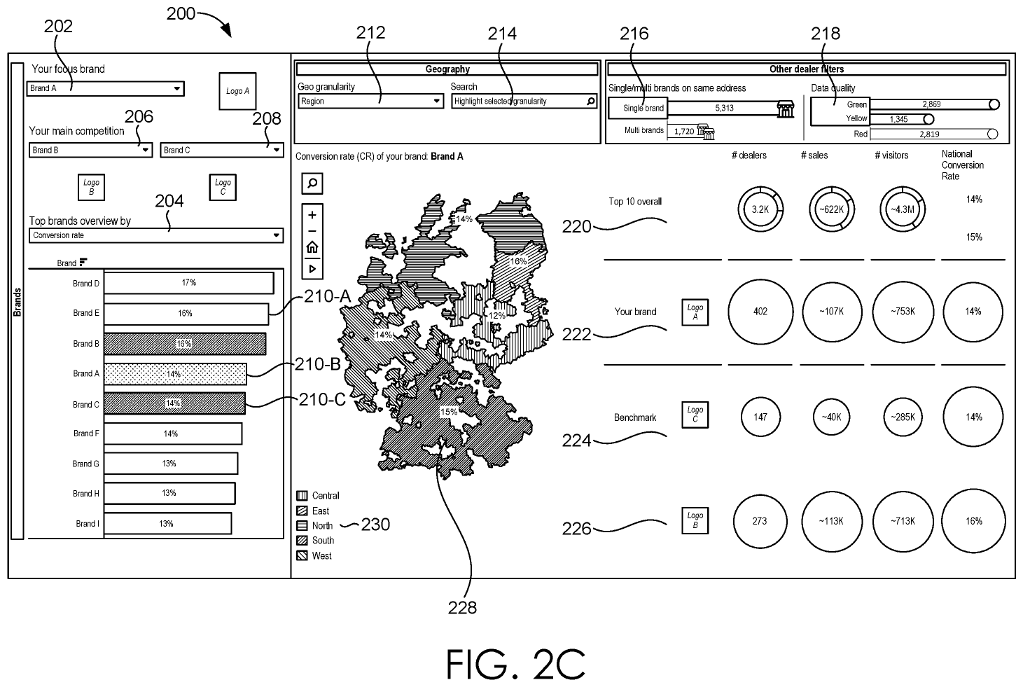

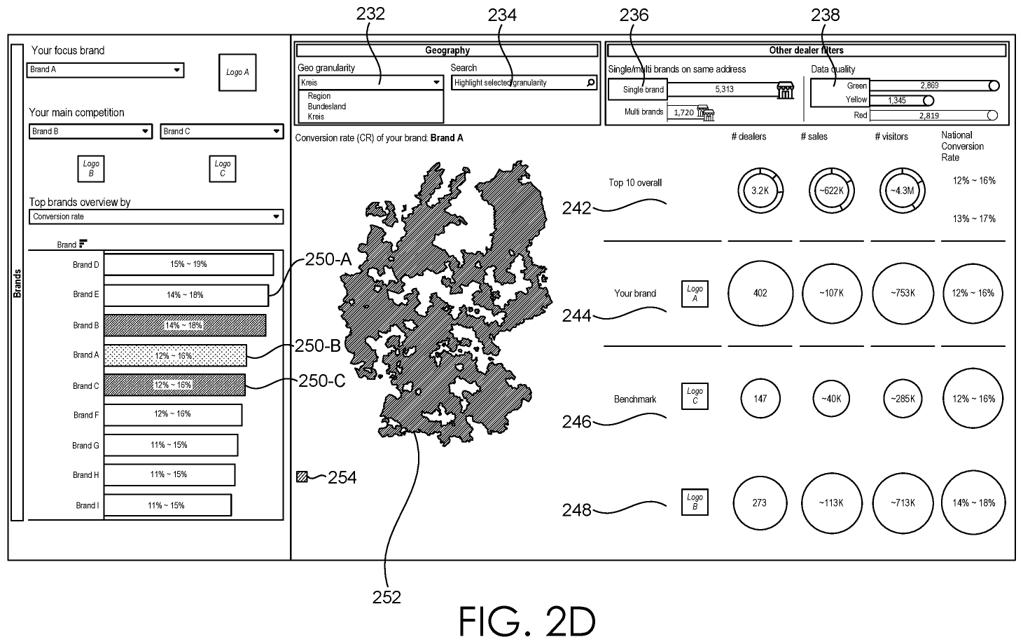

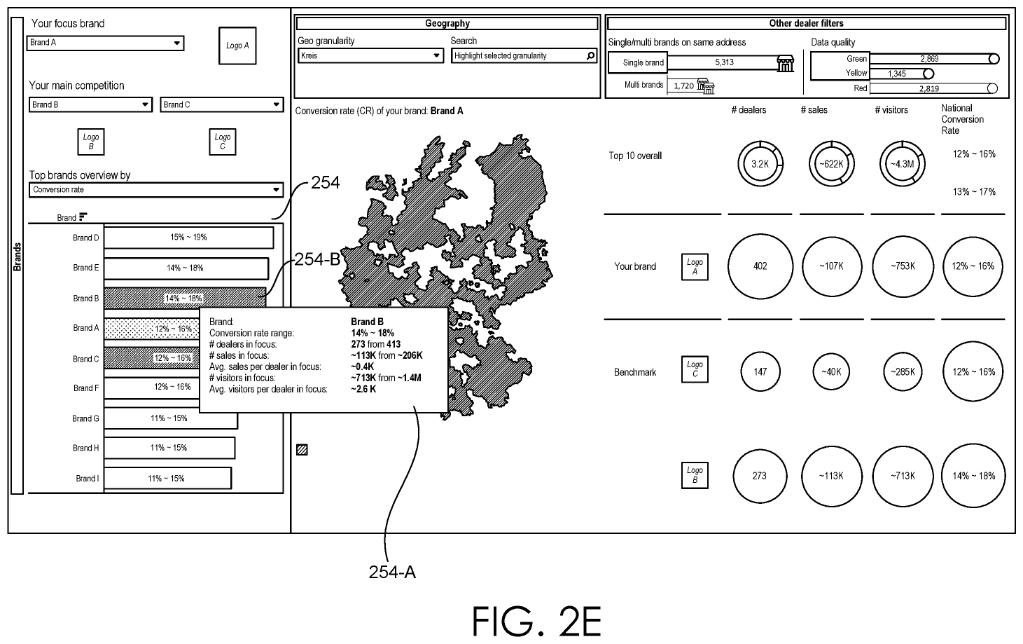

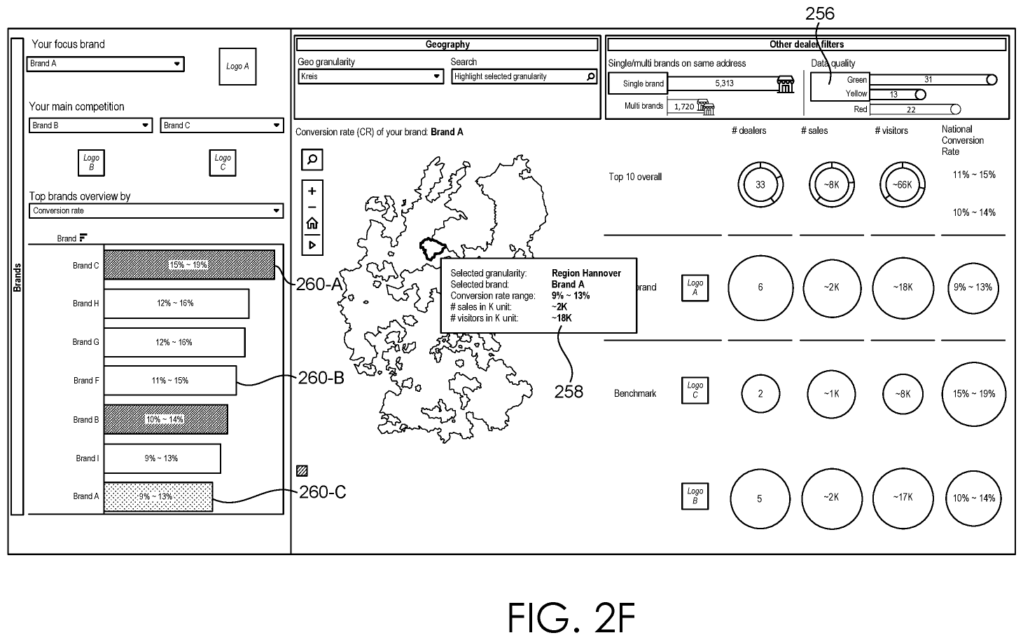

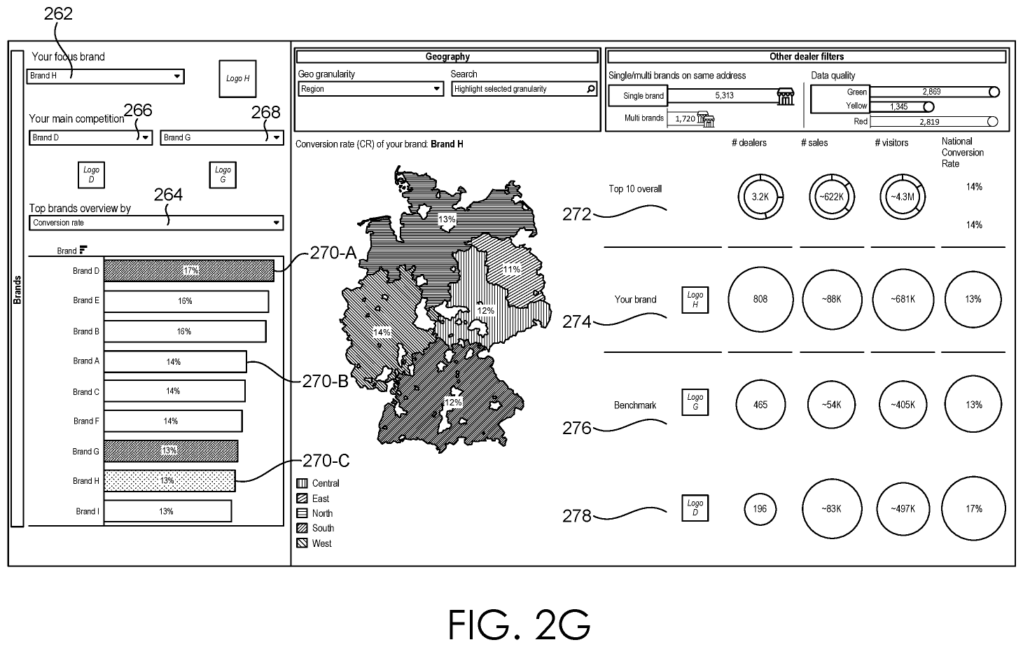

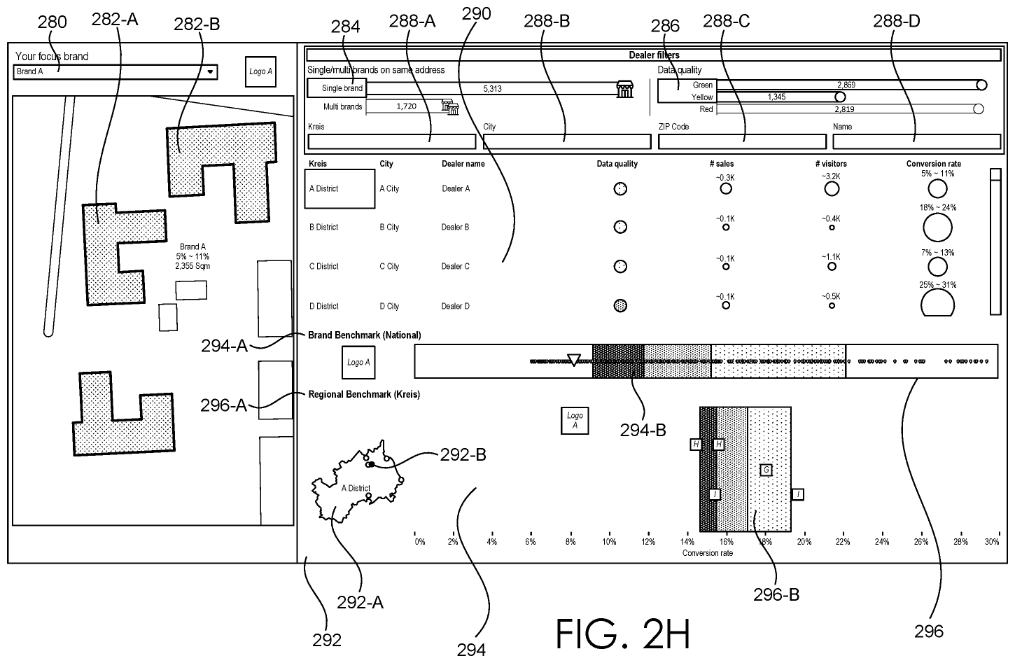

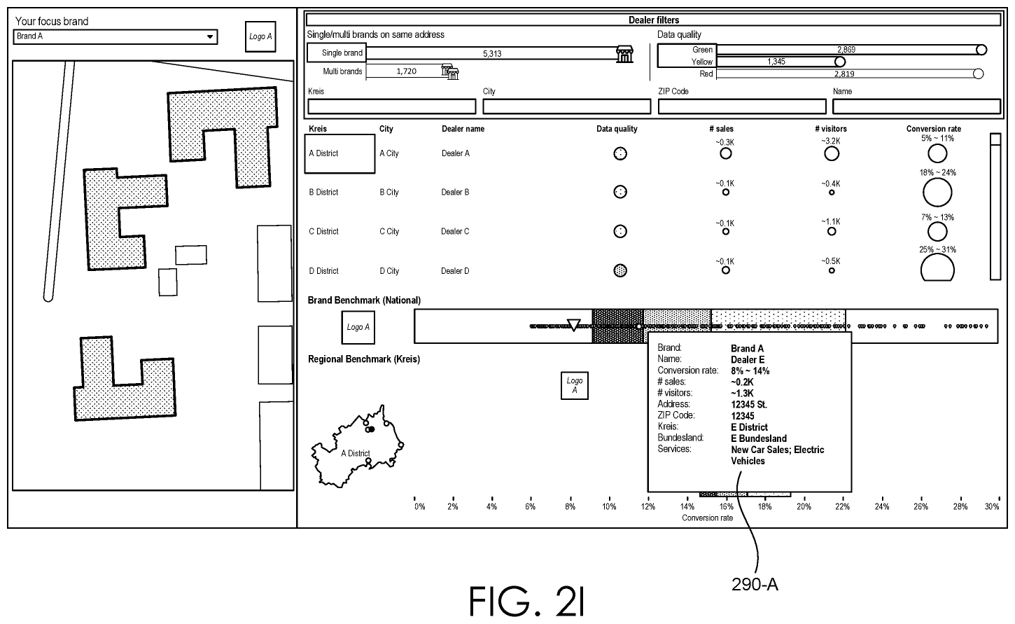

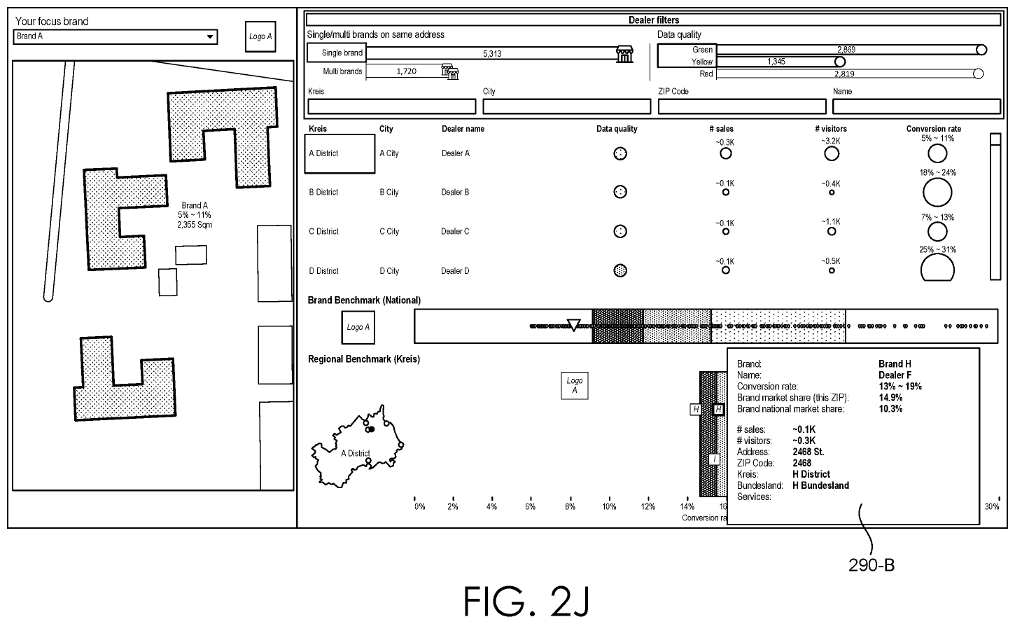

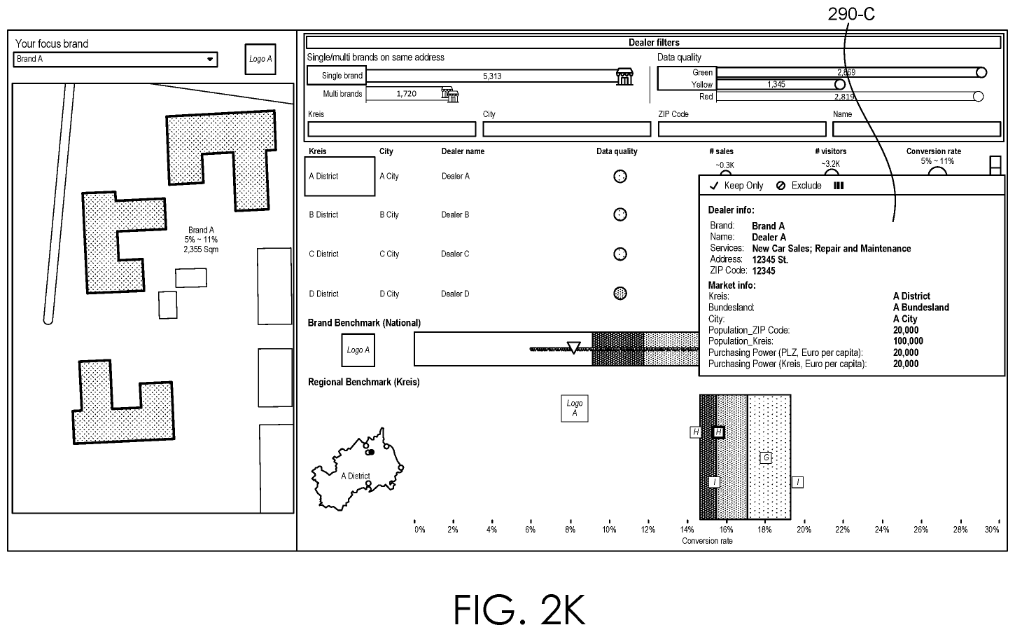

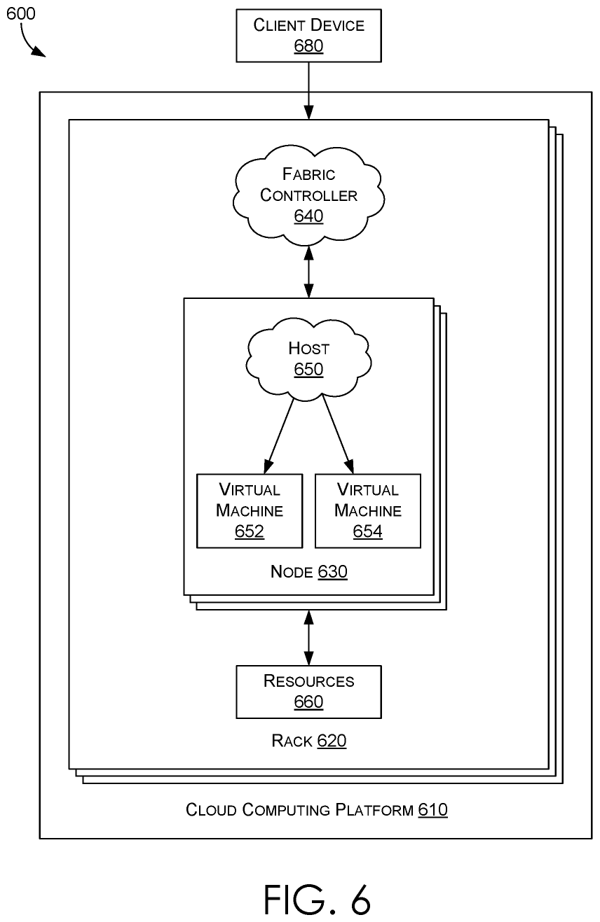

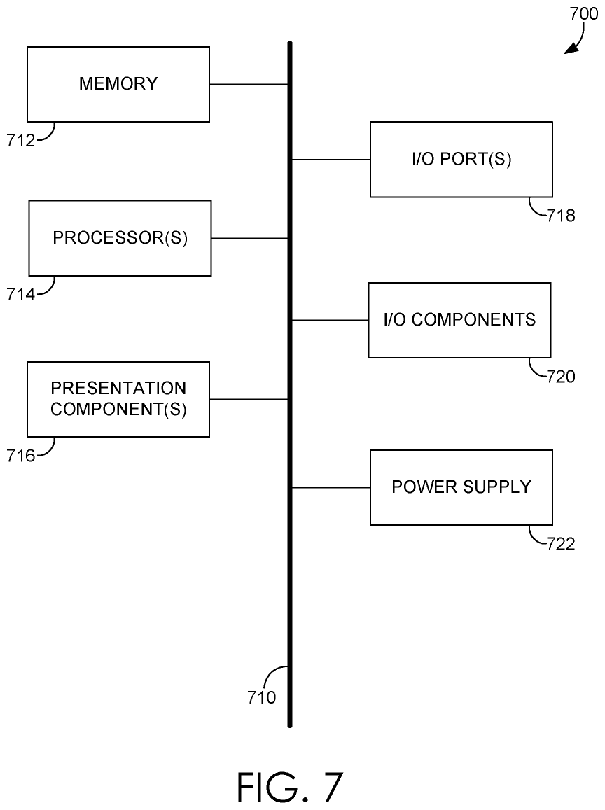

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example data analytics system 100 in which methods of the present disclosure may be employed. In particular, FIG. 2A shows a high level architecture of the data analytics system 100 in accordance with implementations of the present disclosure. Among other engines, managers, generators, selectors, or components not shown (collectively referred to herein as “components”), the technical solution environment of data analytics system 100 corresponds to FIGS. 1A and 1B.

With reference to FIG. 2A, FIG. 2A illustrates automotive data analytics engine 110; automotive data analytics client device 110A and automotive data analytics engine client 110B; data sources 120; automotive data computation engine 130 having statistical models 132, auxiliary computation engine 134, adaptation computation data 134A, and results data classification computation data 134B; conversion rate engine 140 having visitor data 142 and cars sold data 144; and rules store 150 having rules 152; and automotive analytics interfaces configuration engine 160 having automotive data analytics data 162 and visualization interface data 164.

The automotive data analytics engine 110 is responsible for providing an automotive data analytics service in the automotive data analytics system 100. The automotive data analytics service is provided via the automotive data analytics engine 100 (i.e., an automotive market intelligence engine) that includes conversion rate engine to generate conversion rates for different types of car dealerships. A conversion rate refers to a number of visitors to a car dealership location who—are inferred to—have bought cars from the car dealership location out of a total number of visitors to the car dealership.

The automotive data analytics engine 100 includes a conversion rate engine 140 that accesses visitor data 142 and car sold data 144 to generate the conversion rate. The visitor data 142 can include a count of a number of visitors associated with a car dealership. The count of the number visitors is generated based on building footprint data and location tracking data. The building footfall data defines a spatial region for tracking mobile devices as location tracking data. A subset of the mobile devices are selected as visitors to the car dealership. For example, the automotive data computation engine 130 can use rules 142 to filter and identify a subset of mobile devices. A rule can indicate that any mobile device tracked via an employee entrance are filtered out as potential buying customers (i.e., visitors). The subset of mobile devices are used to infer the count of the number of visitors to the car dealership.

The car sold data 144 can include a count of a number of cars sold. The count of the number of cars sold is based on a number of registrations allocated to a car dealership using an automotive data analytics models. The number of registrations allocated to the car dealership are generated based on a total number of car registrations of a geographic region associated with the car dealership. The total number of car registrations can be for a specified period of time (e.g., one month, three months, six months, one year). The automotive data analytics model compute the number of registrations allocated to the car dealership from the total number of car registrations of the geographic region associated with the car dealership. The automotive data analytics model is a distribution model that is calibrated based on historical data comprising car registration data, car registration geographic region data, and car dealership location data.

The automotive data analytics engine 100 supports generating a conversion rate and communicating the conversion rate. The conversion rate can be communicated to cause display of the conversion rate in combination with the car dealership (i.e., the name of the car dealership or other identifier of the car dealership) on an automotive analytics data interface. The conversion rate can be displayed with one or more automotive data analytics graphical interface elements. The automotive data analytics interface supports presenting automotive data analytics results data 136—including the conversion rate—for a plurality of car dealerships and benchmarking data—including conversion rate comparison data—for the plurality of car dealerships.

As such, the automotive data analytics engine 100 is configured to generate and calibrate the automotive data analytics model based on any of the following: the car dealership information data, building footprint data, location tracking data, car registration data, and sales data. The automotive data analytics engine 100 is further configured for analyzing input using the automotive data analytics model for a plurality of car dealerships; based on analyzing the input data, generating automotive data analytics results data for the plurality of car dealerships; and communicating the automotive data analytics results data, where the automotive data analytics results data includes conversion rate comparison data of the plurality of car dealerships.

The automotive data analytics engine 100 is also configure for receiving a request for automotive data analytics results data and generating automotive data analytics results data associated with a single-brand dealership and a multi-brand car dealership. The automotive data analytics results data 136 can be communicated to cause presentation of the automotive data analytics results data associated with the single-brand car dealership, the automotive data analytics results data of the single-brand car dealership includes a conversion rate of the single-brand car dealership. The automotive data analytics results data 136 can also be communicated to cause presentation of automotive data analytics results data associated with the multi-brand car dealership, the automotive data analytics results data of the multi-brand car dealership includes a conversion rate of the multi-brand car dealership.

The automotive data analytics client device 110A having the automotive data analytics engine client 110B is configured to receive automotive data analytics results data 136 and cause presentation of the automotive data analytics results data. The automotive data analytics engine client is further configured for communicating a request for automotive data analytics results data and based on the request, receiving automotive data analytics results data associated with a single-brand dealership and a multi-brand car dealership. The automotive data analytics engine client can cause presentation of the automotive data analytics results data associated with a single-brand car dealership, the automotive data analytics results data of the single-brand car dealership includes a conversion rate of the single-brand car dealership; or cause presentation of automotive data analytics results data associated with a multi-brand car dealership, the automotive data analytics results data of the multi-brand car dealership includes a conversion rate of the multi-brand car dealership.

With reference to FIG. 2B, FIG. 2B illustrates an automotive data analytics engine 110 and automotive data analytics engine client 110B for that performing corresponding operations below for providing the automotive data analytics service. At block 10, aggregate car dealership data, building footprint data, location tracking data, car registration data, and sales data. At block 12, process the car dealership data, building footprint data, location tracking data, car registration data using an automotive data computation engine. At block 14, generate and calibrate an automotive data analytics model based on any of the following car dealership data, building footprint data, location tracking data, car registration data, and sales data. At block 16, generate automotive data analytics results data based on analyzing input data using the automotive data analytics model.

At block 18, access a count of a number of visitor associated with a car dealership. The count of the number visitors associated with the car dealership is generated based on building footprint data and location tracking data. At block 20, access a count of a number of cars sold associated with the car dealership, the count of the number of cars sold is generated based on a number of car registrations allocated to the car dealership using an automotive data analytics model. At block 22, generate a conversion rate for the dealership based on the count of the number of visitors and the count of the number of cars sold. At block 24, communicate the conversion rate for the car dealership.

At block 26, communicate a request for automotive data analytics results data. At block 28, based on the request, receive automotive data analytics results data associated with a single-brand dealership and a multi-brand dealership. At block 30, cause presentation of the automotive data analytics results data associated with the single brand car dealership, the automotive data analytics results data of the single-brand car dealership comprising a conversion rate of the single-brand car dealership. At block 32, cause presentation of automotive data analytics results data associated with the multi-brand car dealership, the automotive data analytics results data of the multi-brand car dealership comprising a conversion rate of the multi-brand car dealership.

With reference to FIGS. 2C-2K, FIG. 2C-2K illustrates aspects—interface representations—associated with the automotive data analytics engine 110, the automotive data analytics interfaces configuration engine 160, and the automotive data analytics client 110B. At a high level, the automotive data analytics interfaces configuration engine 160 operates to generate interface data (e.g., automotive data analytics data 162 and visualization interface data 164). Interface data includes user interface elements, automotive data analytics graphical interface elements, automotive data analytics results data, and instructions on how to generate corresponding user interfaces that support interactions between users and the data analytics system.

User interfaces allow effective operation and control by users while the data analytics simultaneously perform computing operations. Interface data can include graphical user interfaces that allow users to interact with the data analytics system (e.g., automotive data analytics service) through graphical user interface elements. A graphical user interface can include a dashboard that provides a visual display of data (e.g., automotive data analytics data 162 and visualization interface data 164). Automotive data analytics data 162 and visualization interface data 164 can specifically be associated with conversion rate data of single-branded or multi-branded car dealerships.

With reference to FIG. 2C, FIG. 2C illustrates aspects of an automotive data analytics interface 200 having a brand selector 202, overview selector 204, competitor selector A 206 and competitor selector B 208, a bar chart 210 and corresponding bars for different brands (i.e., 210-A, 210-B, and 210-C). The automotive data analytics interface 200 further includes a geo granularity selector 212, a geographic region search input 214; single-brand and multi-brand filter 216, and data quality filter 218. The automotive data analytics interface 200 also includes a top 10 overall data portion 220, a current brand data portion 222, a first competitor brand data portion 224, a second competitor brand data portion 226; a geographic region map display portion 228, and a geographic region legend portion 230.

The brand selector 202, competitor selector A 204, and competitor selector B 206 can be dropdown menus having a plurality of brands associated with the car dealership information and the car registration data. In FIG. 2C, the focus brand (i.e., Brand A) is selected and can be different from the focus brand in FIG. 2F, and the competitor brands (i.e., Brand B and Brand C) can also be different. The selected brands indicate the automotive data analytics data—including benchmarking and competitor analysis data—that are provided in different portions of the automotive data analytics interface 200. The overview selector 204 can be a dropdown menu for selecting a data feature (e.g., conversion rate) of automotive data analytics data to be graphically displayed on the bar charts. Bars 210-A, 210-B, and 210-C in the bar chart show conversion rates for different brands.

The geo granularity selector 212 can be a dropdown menu for selecting a hierarchical level associated a geographic region of the automotive data analytics results data. The geographic region search input 214 can be a text input bar associated with searching for a specific geographic region. The single-brand and multi-brand filter 216 can support selection of either single-brand or multi-brand to provide corresponding automotive data analytics results data for single-brand car dealerships or multi-brand car dealerships. The single-brand and multi-brand filter 216 further identifies a count of a number of single-brand car dealerships (i.e., 5313) and multi-brand car dealerships (i.e., 1720).

The data quality filter 218 can be used to present automotive data analytics data associated with different classifications (e.g., green, yellow, and red) of automotive data analytics results data. The different classifications can be associated with a confidence level and corresponding score of the automotive data analytics results data—including the conversion rates of the car dealership. The data quality filter 218 further identifies a count of a number of car dealerships associated with each classification.

With reference to FIG. 2D, FIG. 2D illustrates aspects of an automotive data analytics interface 200 having a geo granularity selector 232, a geographic region search input 234, single-brand and multi-brand filter 236, and data quality filter 238, top 10 overall data portion 242, a current brand data portion 244, a first competitor brand data portion 246, a second competitor brand data portion 248, a bar chart 250 and corresponding bars for different brands (i.e., 250-A, 250-B, and 250-C), a geographic region map display portion 252, and a geographic region legend portion 254.

The different portions of the automotive data analytics interface 200 can be support providing data corresponding to a number of dealers, numbers of sales, number of visitors, and a geographic region conversion rate (e.g., a national conversion rate). The top 10 overall data portion 242, a current brand data portion 244, a first competitor brand data portion 246, a second competitor brand data portion 248 each include automotive data analytics data that correspond to a number of dealers, numbers of sales, number of visitors, and a geographic region conversion rate. Bars 250-A, 250-B, and 250-C in the bar chart show conversion rates for different brands.

With reference to FIG. 2E, FIG. 2E illustrates aspects of an automotive data analytics interface 200 having details pop-up window 254-A and corresponding bar 254-B in the bar chart data portion 254. The details pop-up window 254 can include information associated with a selected brand (e.g., brand B corresponding to bar 254-B). The information can include brand, name, conversion rate range, number of dealers in focus, sales in focus, average sales per dealer in focus, visitors in focus, and average visitors per dealer in focus. The details pop-up window 254-A can be generated based on a selection action or a hover action over a designated portion (e.g., bar 254-B) of the automotive data analytics interface 200.

With reference to FIG. 2F, FIG. 2F illustrates aspects of an automotive data analytics interface 200 having data quality filter 256, details pop-up window 258, a bar chart 260 and corresponding bars for different brands (i.e., 260-A, 260-B, and 260-C). The details pop-up window 258 can include information associated with a selected geographical region. The information can include a granularity, a brand, a conversion rate range, number of sales, and number of visitors. The details pop-up window 258 can be generated based on a selection action or a hover action over a designated portion of the automotive data analytics interface 200.

The data quality filter 256 can be used to present automotive data analytics data associated with different classifications (e.g., green, yellow, and red) of automotive data analytics results data. The different classifications can be associated with a confidence level and corresponding score of the automotive data analytics results data—including the conversion rates of the car dealership. The automotive data analytics data corresponds to the selected geographic region. A count of a number of car dealerships—in the geographic region—associated with each classification can be displayed along with the corresponding classification in the data quality filter 256. Bars 260-A, 260-B, and 260-C in the bar chart show conversion rate ranges for different brands—also for the selected geographic region.

With reference to FIG. 2G, FIG. 2G illustrates aspects of an automotive data analytics interface 200 a brand selector 262, overview selector 264, competitor selector A 266 and competitor selector B 268, a bar chart 270 and corresponding bars for different brands (i.e., 270-A, 270-B, and 270-C). The automotive data analytics interface 200 also includes a top 10 overall data portion 272, a current brand data portion 274, a first competitor brand data portion 276, a second competitor brand data portion 278; a geographic region map display portion 228. The brand selector 262, competitor selector A 266, and competitor selector B 268 can be dropdown menus having a plurality of brands associated with the car dealership information and the car registration data. In FIG. 2G, the focus brand (i.e., brand H) is different from the focus brand in FIG. 2C, and the competitor brands (i.e., brand D and brand G) are also different. The selected brands indicate the automotive data analytics data—including benchmarking and competitor analysis data—that is provided in different portions of the automotive data analytics interface 200.

The different portions of the automotive data analytics interface 200 can be support providing data corresponding to a number of dealers, numbers of sales, number of visitors, and a geographic region conversion rate (e.g., a national conversion rate). The top 10 overall data portion 272, a current brand data portion 274, a first competitor brand data portion 276, a second competitor brand data portion 278 each include automotive data analytics data that correspond to a number of dealers, numbers of sales, number of visitors, and a geographic region conversion rate (e.g., national conversion rate). The overview selector 264 can be a dropdown menu for selecting a data feature (e.g., conversion rate) of automotive data analytics data to graphical display on the bar charts. Bars 270-A, 270-B, and 270-C in the bar chart show conversion rates for different brands.

With reference to FIG. 2H, FIG. 2H illustrates aspects of an automotive data analytics interface 200 having brand selector 280, building footprint data portion 280 including a first building polygon 282-A and a second building polygon 282-B, a single-brand and multi-brand filter 284, a data quality filter 286, a plurality of geographic region selectors (e.g., kreis 288-A, city 288-B, ZIP Code 288-C, and name 288-D), a conversion rate data portion 290, geographic region data portion 290 (including data quality, number of sales, number of visitors, and conversion rate), a geographic region data portion 292 having a first hierarchical region identifier 292-A and a second hierarch region identifier 292-B; a first benchmarking data portion 294, and a second benchmarking data portion 296. The brand selector 280 can be a dropdown menu having a plurality of brands associated with car dealership information and the car registration data. The building footprint data portion 280 can be used to display building footprint data including polygons (e.g., first building polygon 282-A and a second building polygon 282-B) building size, and other building footprint data.

The single-brand and multi-brand filter 284 can be used to present the automotive data analytics data associated with single-brand car dealerships or multi-brand car dealerships. A count of a number of car dealerships associated with a single brand or multiple brands can be displayed along with the single-brand and multi-brand filter 284. The data quality filter 286 can be used to present automotive data analytics data associated with different classifications (e.g., green, yellow, and red) of automotive data analytics results data. The different classifications can be associated with a confidence level or score of the automotive data analytics results data—including the conversion rate data and conversion rate comparison data of car dealerships. A count of a number of car dealerships associated with each classification can be displayed along with the corresponding classification in the data quality filter 286. The first benchmarking data portion 294 can include a benchmark data identifier 294-A and a data visualization 294-B based on conversion rate comparison data; and the second benchmarking data portion 296 can include a benchmark data identifier 296-A and a data visualization 296-B based on conversion rate comparison data.

With reference to FIG. 2I, FIG. 2I illustrates aspects of an automotive data analytics interface 200 having details pop-up window 290-A. The details pop-up window 290-A can include information associated with a selected brand (e.g., a brand A) and a selected car dealership (e.g., Dealer E). The information can include brand, name, conversion rate range, number of visitors, address, postal code, kreis, bundesland, and services. The details pop-up window 290-B can be generated based on a selection action or a hover action over a designated portion of the automotive data analytics interface 200.

With reference to FIG. 2J, FIG. 2J illustrates aspects of an automotive data analytics interface 200 having details pop-up window 290-B. The details pop-up window 290-B can include information associated with a selected brand (e.g., brand H) and a selected car dealership (e.g., Dealer F). The information can include brand, name, conversion rate range, brand market share, number of sales, number of visitors, address, postal code, kreis, bundesland, and services. The details pop-up window 290-B can be generated based on a selection action or a hover action over a designated portion of the automotive data analytics interface 200.

With reference to FIG. 2K, FIG. 2K illustrates aspects of an automotive data analytics interface 200 having details pop-up window 290-C. The details pop-up window 290-C can include car dealership information and market information. The car dealership information can include brand, car dealership name, services, address, and postal code; and the market information can include kreis, bundesland, city, population, and purchasing power. It is contemplated that different types of geographical region designations and identifiers can be used with embodiments described herein. The details pop-up window 290-C can be generated based on a selection action or a hover action over a designated portion of the automotive data analytics interface 200.

### EXEMPLARY METHODS

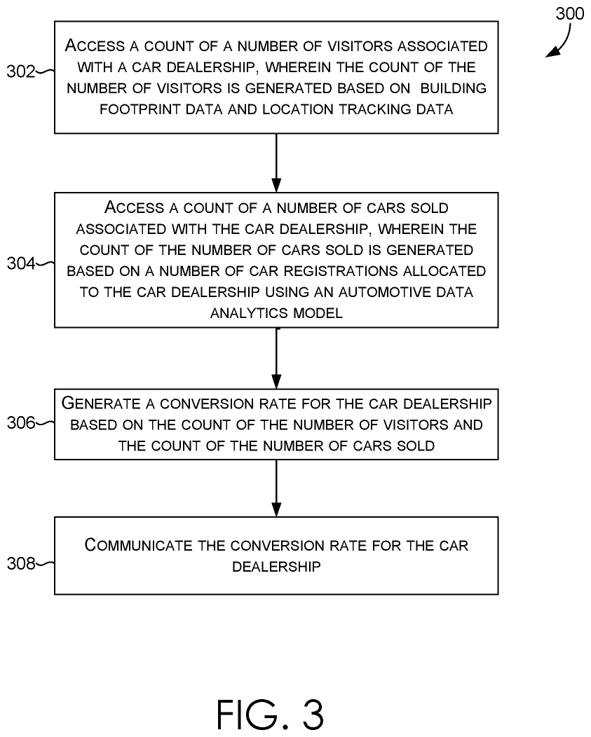

With reference to FIGS. 3, 4 and 5, flow diagrams are provided illustrating methods for providing an insight capturing interface of an automotive data analytics engine in a data analytics system. The methods may be performed using the data analytics system described herein. In embodiments, one or more computer-storage media having computer-executable or computer-useable instructions embodied thereon that, when executed, by one or more processors can cause the one or more processors to perform the methods (e.g., computer-implemented method) in the data analytics system (e.g., a computerized system or computing system).

Turning to FIG. 3, a flow diagram is provided that illustrates a method 300 for providing an automotive data analytics service associated with an automotive data analytics engine in a data analytics system. At block 302, access a count of a number of visitors associated with a car dealership. The count of the number of visitors is generated based on car dealership data, building footprint data, and location tracking data. At block 304, access a count of a number of cars sold associated with the car dealership. The count of the number of car sold is generated based on a number of car registrations allocated to the car dealership using an automotive data analytics model. At block 306, generate a conversion rate for the car dealership based on the count of the number of visitors and the count of the number of cars sold. At block 308, communicate the conversion rate for the car dealership.

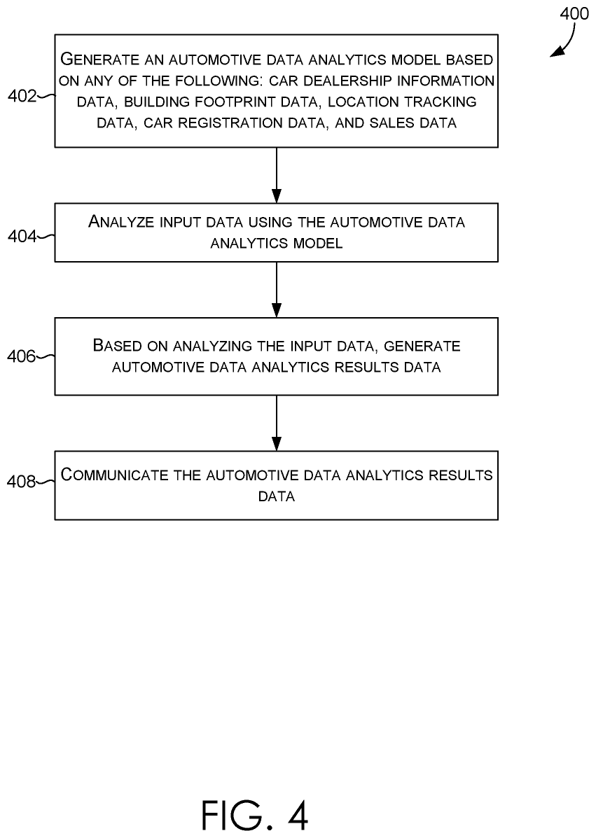

Turning to FIG. 4, a flow diagram is provided that illustrates a method 400 for providing an automotive data analytics service associated with an automotive data analytics engine in a data analytics system. At block 402, generate an automotive data analytics model based on any (optionally combination) of the following: car dealership data, building footprint data, location tracking data, car registration data, and sales data. At block 404, analyze input data using the automotive data analytics model. At block 406, based on analyzing the input data, generate automotive data analytics results data. At block 408, communicate the automotive data analytics results data.

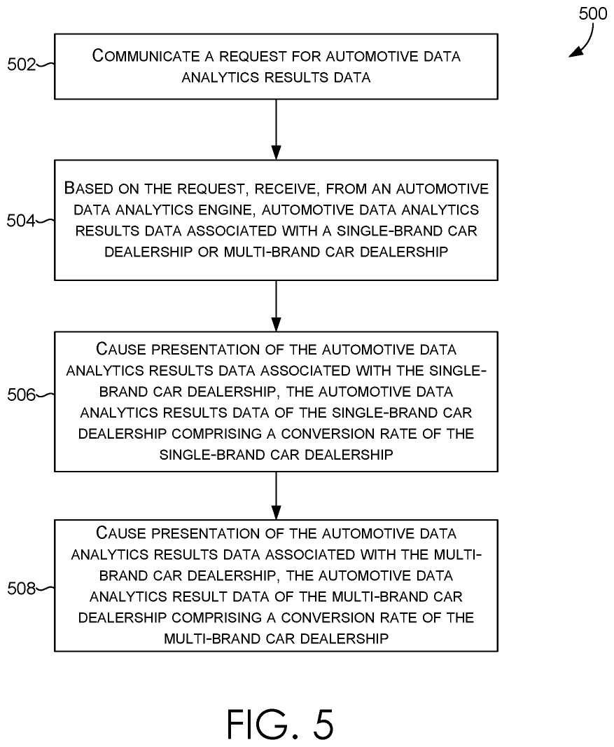

Turning to FIG. 5, a flow diagram is provided that illustrates a method 500 for providing an automotive data analytics service associated with an automotive data analytics engine in a data analytics system. At block 502, communicate a request for automotive data analytics results data. At block 504, based on the request, receive, from an automotive data analytics engine, automotive data analytics results data associated with a single-brand car dealership or a multi-brand car dealership. At block 506, cause presentation of the automotive data analytics results data associated with the single-brand car dealership. The automotive analytics results data of the single-brand car dealership comprising a conversion rate of the single-brand car dealership. At block 508, cause presentation of the automotive data analytics results data associated with the multi-brand car dealership. The automotive data analytics results data of the multi-brand car dealership comprising a plurality of conversion rates of the multi-brand car dealership.

### ADDITIONAL SUPPORT FOR DETAILED DESCRIPTION OF THE INVENTION

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Distributed Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at an automotive data analytics engine, a count of a number of visitors associated with a car dealership, wherein the count of the number of visitors is generated based on building footprint data and location tracking data;
accessing a count of a number of cars sold associated with the car dealership, wherein the count of the number of cars sold is based on a number of registrations allocated to the car dealership using an automotive data analytics model;
generating a conversion rate for the car dealership based on the count of the number of visitors and the count of the number of cars sold; and
communicate the conversion rate for the car dealership.

2. The system of claim 1, wherein the building footfall data defines a spatial region for tracking mobile devices as location tracking data, wherein a subset of the mobile devices selected as visitors to the car dealership are used to infer the count of the number of visitors to the car dealership.

3. The system of claim 1, wherein the number of registrations allocated to the car dealership is generated based on a total number of car registrations of a geographic region associated with the car dealership, wherein the automotive data analytics model computes the number of registrations allocated to the car dealership from the total number of car registrations of the geographic region.

4. The system of claim 3, wherein the automotive data analytics model is a distribution model that is calibrated based on historical data comprising car registration data, car registration geographic region data, and car dealership location data.

5. The system of claim 1, wherein the conversion rate is communicated to cause display of the conversion rate in combination with the car dealership on an automotive data analytics data interface with one or more automotive data analytics interface elements.

6. The system of claim 5, wherein the automotive data analytics data interface further supports presenting automotive data analytics results data comprising conversion rate data for a plurality of car dealerships and conversion rate comparison data for the plurality of car dealerships.

7. The system of claim 1, wherein the automotive data analytics engine is configured for:
generating and calibrating the automotive data analytics model based on any of the following: the car dealership information data, building footprint data, location tracking data, car registration data, and sales data;
analyzing input using the automotive data analytics model for a plurality of car dealerships;
based on analyzing the input data, generating automotive data analytics results data for the plurality of car dealerships; and
communicate the automotive data analytics results data, wherein the automotive data analytics results data comprises conversion rate comparison data of the plurality of car dealerships.

8. The system of claim 1, wherein the automotive data analytics engine is configured for:
receiving a request for automotive data analytics results data;
generating automotive data analytics results data associated with a single-brand dealership and a multi-brand car dealership;
communicating the automotive data analytics results data to cause presentation of the automotive data analytics results data associated with the single-brand car dealership, the automotive data analytics results data of the single-brand car dealership comprising a conversion rate of the single-brand car dealership; and
communicating the automotive data analytics results data to cause presentation of automotive data analytics results data associated with the multi-brand car dealership, the automotive data analytics results data of the multi-brand car dealership comprising a plurality of conversion rates of the multi-brand car dealership.

9. The system of claim 1, further comprising automotive data analytics engine client configured for:
communicating a request for automotive data analytics results data;
based on the request, receiving automotive data analytics results data associated with a single-brand dealership and a multi-brand car dealership;
cause presentation of the automotive data analytics results data associated with the single-brand car dealership, the automotive data analytics results data of the single-brand car dealership comprising a conversion rate of the single-brand car dealership; or
cause presentation of automotive data analytics results data associated with the multi-brand car dealership, the automotive data analytics results data of the multi-brand car dealership comprising a plurality of conversion rates of the multi-brand car dealership.

10. A computer-implemented method, the method comprising:
generating an automotive data analytics model based the following: car dealership data, building footprint data, location tracking data, car registration data, and sales data;
analyze input using the automotive data analytics model;
based on analyzing the input data, generate automotive data analytics results data; and
communicate the automotive data analytics results data, wherein the automotive data analytics results data comprises conversion rates that are caused to be displayed in combination with corresponding car dealerships on an automotive data analytics data interface with one or more automotive data analytics interface elements.

11. The method of claim 10, wherein a conversion rate for a car dealership is generated based on a count of a number of visitors and a count of a number of cars sold that both correspond to a car dealership.

12. The method of claim 11, wherein the building footfall data defines a spatial region for tracking mobile devices as location tracking data, wherein a subset of the mobile devices selected as visitors to the car dealership are used to infer the count of the number of visitors to the car dealership.

13. The method of claim 11, wherein the number of registrations allocated to the car dealership is generated based on a total number of car registrations of a geographic region associated with the car dealership, wherein the automotive data analytics model computes the number of registrations allocated to the car dealership from the total number of car registrations of the geographic region.

14. The method of claim 13, wherein the automotive data analytics model is a distribution model that is calibrated based on historical data comprising car registration data, car registration geographic region data, and car dealership location data.

15. The method of claim 10, wherein the automotive data analytics data interface further supports presenting automotive data analytics results data comprising conversion rate data for a plurality of car dealerships and conversion rate comparison data for the plurality of car dealerships.

16. The method of claim 10, wherein the automotive data analytics data interface further supports presenting and filtering automotive data analytics results data based on classification identifiers that indicate a level of confidence of the automotive data analytics results data.

17. One or more computer-storage media having computer-executable instructions embodied thereon that, when executed by a computing system having a processor and memory, cause the processor to perform operations comprising:
communicating a request for automotive data analytics results data;
based on the request, receiving automotive data analytics results data associated with a single-brand dealership and a multi-brand car dealership, wherein the automotive data analytics results data comprises conversion rates for the single-brand dealerships and the multi-brand car dealership, wherein the conversion rates are generated based on an automotive data analytics model;
causing presentation of the automotive data analytics results data associated with the single-brand car dealership, the automotive data analytics results data of the single-brand car dealership comprising a conversion rate of the single-brand car dealership; or
causing presentation of automotive data analytics results data associated with the multi-brand car dealership, the automotive data analytics results data of the multi-brand car dealership comprising a conversion rate of the multi-brand car dealership.

18. The media of claim 17, wherein the conversion rates are communicated to cause display of the conversion rates in combination with corresponding car dealerships on an automotive data analytics data interface with one or more automotive data analytics interface elements.

19. The media of claim 18, wherein the automotive data analytics data interface further supports presenting automotive data analytics results data comprising conversion rate data for a plurality of car dealerships and benchmarking data for the plurality of car dealerships.

20. The media of claim 15, wherein the automotive data analytics model is a distribution model that is calibrated based on historical data comprising car registration data, car registration geographic region data, and car dealership location data.
